(19) United States
(12) Patent Application Publication
(10) Pub. No.: US 2008/0006966 A1
(43) Pub. Date: Jan. 10, 2008

(54) Method for building three-dimensional objects containing metal parts

(75) Inventor: Dominic F. Mannella, Minnetonka, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Stratasys, Inc., Eden Prairie, MN (US)

(21) Appl. No.: 11/483,020

(22) Filed: Jul. 7, 2006

(51) Int. Cl. B29C 41/20

(52) U.S. Cl. 264/259; 264/265; 264/279; 264/279.1; 264/308

(57) ABSTRACT

A method for building a three-dimensional object, the method includes positioning a metal part within a build chamber of an extrusion-based layered deposition system, where the metal part comprising a polymer-coated surface. The method also includes depositing a build material on the polymer-coated surface of the metal part, wherein the deposited build material cools to form at least a portion of a layer of the three-dimensional object.

### BACKGROUND OF THE INVENTION

The present invention relates to methods of building three-dimensional (3D) objects using rapid manufacturing systems. In particular, the present invention relates to methods of building 3D objects that contain metal parts with the use of extrusion-based layered manufacturing systems.

An extrusion-based layered manufacturing system (e.g., fused deposition modeling systems developed by Stratasys, Inc., Eden Prairie, Minn.) is used to build a 3D object from a computer-aided design (CAD) model in a layer-by-layer manner by extruding a thermoplastic build material. The build material is extruded through a nozzle carried by an extrusion head, and is deposited as a sequence of roads on a substrate in an x-y plane. The extruded build material fuses to previously deposited build material, and solidifies upon a drop in temperature. The position of the extrusion head relative to the base is then incremented along a z-axis (perpendicular to the x-y plane), and the process is then repeated to form a 3D object resembling the CAD model.

Movement of the extrusion head with respect to the base is performed under computer control, in accordance with build data that represents the 3D object. The build data is obtained by initially slicing the CAD model of the 3D object into multiple horizontally sliced layers. Then, for each sliced layer, the host computer generates a build path for depositing roads of build material to form the 3D object;

3D objects built with rapid manufacturing techniques are used for a variety of industrial and commercial applications. For many of these applications, there is a growing need for the incorporation of metal parts (e.g., metal bearings and bushings) in the plastic 3D objects. Accordingly, there is a need for methods of building 3D objects containing metal parts that are reliable and efficient.

### BRIEF SUMMARY OF THE INVENTION

The present invention relates to a method for building a three-dimensional object in a layer-by-layer manner using an extrusion-based layered deposition system. The method includes positioning a metal part within a build chamber of the system, where the metal part has a polymer-coated surface that increases adhesive properties of the metal part. The method further includes depositing a build material on the polymer-coated surface of the metal part, where the deposited build material cools to form at least a portion of a layer of the three-dimensional object.

### BRIEF DESCRIPTION OF THE DRAWINGS

FIG. 1 is a top view of a 3D object disposed on a substrate of an extrusion-based layered deposition system, where the 3D object contains a metal part.

FIG. 2 is an expanded sectional view of section 2-2 taken in FIG. 1, showing the metal part disposed between consecutive layers of the 3D object, where the scale along a z-axis is exaggerated.

FIG. 3 is a flow chart of a method for generating build data representing the 3D object.

FIG. 4 is a flow chart of a method for building the 3D object based on the generated build data.

### DETAILED DESCRIPTION

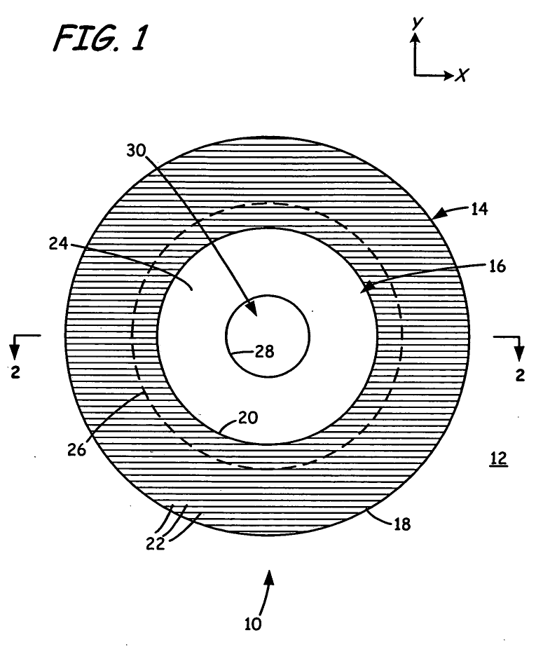

FIG. 1 is a top view of 3D object 10 disposed on substrate 12 of an extrusion-based layered deposition system (not shown), where 3D object 10 is an exemplary 3D object built pursuant to the method of the present invention. As shown, 3D object 10 includes top layer 14 and metal part 16, where metal part 16 is inserted between top layer 14 and previously deposited layers (not shown in FIG. 1). Top layer 14 is an annular layer of a solidified thermoplastic build material extending in an x-y plane (i.e., a plane defined by an x-axis and a y-axis, shown in FIG. 1). The build material is deposited as outer perimeter road 18, inner perimeter road 20, and a plurality of back-and-forth raster roads 22.

Metal part 16 is annular ring of a metallic material, which includes top surface 24, outer diameter 26, and inner diameter 28, where inner diameter 28 defines inner orifice 30. Metal part 16 is an example of a suitable metal part that may be inserted in a 3D object pursuant to the method of the present invention. As shown, a portion of top surface 24 of metal part 16, adjacent outer diameter 26, extends below top layer 14. As discussed below, top surface 24 is a polymer-coated surface that increases the adhesive properties of metal part 16. This correspondingly causes build material deposited on top of metal part 16 to adhere to top surface 24.

During the manufacture of 3D object 10, metal part 16 is inserted on top of the previously deposited layers (manually or in an automated manner). Build material is then deposited as outer perimeter road 18, inner perimeter road 20, and raster roads 22 to form top layer 14 on top surface 24 and on the previously deposited layers.

For uncoated metal parts, the deposited roads of build material do not adequately adhere to the top surfaces of the metal parts. This may be due to a variety of factors, such as shear effects induced by thermal shrinking of the build material, hydrocarbon and/or water layers formed on the surfaces of the metal parts, and repulsive Van der Waals forces between the build material and the surfaces of the metal parts.

The result of the low adhesion is that the deposited roads smear and pull across the metal surfaces, which prevents formation of the given layer and interferes with subsequently deposited layers. For example, when roads of build material smear and pull across a given metal surface, the layer is not properly formed and cannot function as a working surface for subsequently formed layers. This effectively prevents proper formation of the subsequent layers formed above the metal part, which results in the 3D objects that do not match their corresponding CAD models and are aesthetically unpleasing.

However, in contrast, the use of a polymer-coated surface for top surface 24 increases the adhesive properties of metal part 16. This causes the deposited roads of build material to adhere to top surface 24, thereby allowing the deposited roads to remain along their intended build paths. As used herein, the terms “increased adhesive properties”, “increased adhesion”, and the like, refer to an increase in surface energy of top surface 24 of metal part 16, which may be due to chemical bonding, ionic bonding, mechanical bonding (e.g., interlocking and friction), and combinations thereof.

In one embodiment, the polymer-coated surface for top surface 24 also diffuses the thermal energy of deposited build material, thereby reducing the thermal shrinking of the build material. The reduced thermal shrinking reduces shear effects, which may also increase the adhesion between the deposited roads of build material and metal part 16.

As discussed below, the method of the present invention allows 3D object 10 to be built with the use of a polymer-coated surface (i.e., top surface 24). This allows 3D object 10 to be built with metal part 16 in accordance with generated build data from a CAD model.

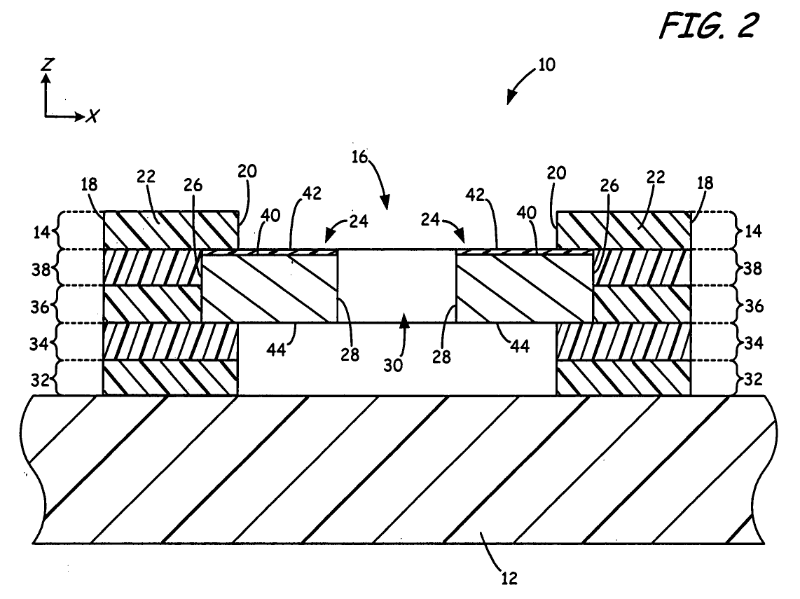

FIG. 2 is an expanded sectional view of section 2-2 taken in FIG. 1, in which the scale along a z-axis is exaggerated for ease of discussion. As shown in FIG. 2, 3D object 10 also includes layers 32, 34, 36, and 38, which are successive layers of build material deposited on substrate 12. Metal part 16 is disposed vertically between layers 14 and 34, and circumferentially within layers 36 and 38.

Top surface 24 of metal part 16 includes metal surface 40 and polymer film 42, where polymer film 42 is adhered to at least a portion of metal surface 40. Preferably, polymer film 42 is disposed at least over the portions of metal surface 40 upon which top layer 14 is formed. This allows the roads of build material forming top layer 14 to be deposited along their intended build paths without smearing or pulling across top surface 24.

Polymer film 42 compositionally includes an adhesion-promoting polymeric material, which is a polymeric material that increases the adhesive properties of metal part 16. In an alternative embodiment, metal part 16 also includes a second film (not shown) disposed on the opposing metal surface of metal surface 40 (shown as metal surface 44 in FIG. 2). The second film may compositionally include the same adhesion-promoting polymeric material as polymer film 42 or may include other types of adhesive materials. This increases the adhesion between metal part 16 and layer 34, thereby reducing the risk of interlayer delamination between metal part 16 and layer 34.

While metal part 16 is shown in FIG. 2 as having a planar top surface 24, metal part 16 may also include top surfaces that are curved and/or include topographical features. For example, with an extrusion-based layered manufacturing systems (e.g., a fused deposition modeling system), the top surface of a given metal part may extend at an angle of about 45 degrees or less from the x-y plane without the extrusion head of the system contacting the metal part during the build process. Additionally, the extrusion head of the system may also be disposed at an angle to the z-axis, thereby allowing extrusion head to move laterally around the metal part while depositing the build material.

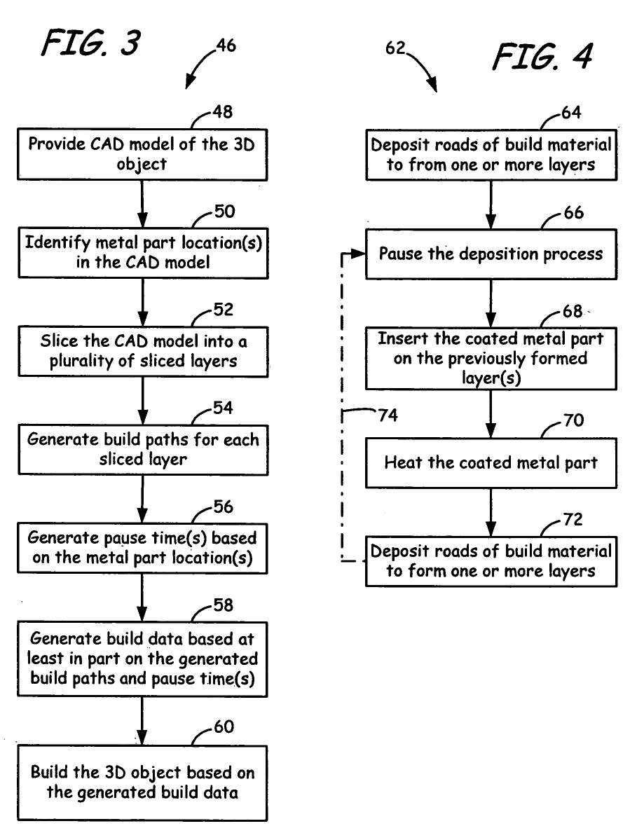

FIG. 3 is a flow diagram of method 46 for generating build data representing 3D object 10. While the following discussion relates to 3D object 10, method 46 is suitable for generating build data representing a variety of 3D object designs containing one or more metal parts. Method 46 includes steps 48-60, and initially involves providing a CAD model of 3D object 10 to a host computer (not shown) (step 48).

The host computer then identifies where metal part 16 is located in the CAD model (step 50). For example, the host computer may scan the CAD model for data that identifies metal part 16. Alternatively, a user may operate the host computer and manually identify the data points in the CAD model that relate to metal part 16. For 3D objects that contain multiple metal parts, step 50 may be repeated for each metal part.

Once the location of metal part 16 is identified, the host computer then slices the CAD model into a plurality of sliced layers oriented in the x-y plane (step 52). The sliced layers are generated around the identified location of metal part 16, and are desirably generated to be substantially even with metal part 16 along the z-axis. For example, as shown above in FIG. 2, the combined thickness of layers 36 and 38 along the z-axis is substantially the same as the thickness of metal part 16 (including polymer film 42, and taking thermal expansion of metal part 16 into account). This reduces the risk of vertically shifting subsequent layers (e.g., top layer 14) during the build process.

After the sliced layers are generated, the host computer then generates a build path for each of the generated sliced layers (step 54). The generated build paths correspond to the roads of deposited build material for each sliced layer (e.g., outer perimeter road 18, inner perimeter road 20, and raster roads 22), and include vector or raster coordinate locations and a deposition timing sequence.

The deposition timing sequence is a set of instructions that direct the extrusion-based layered deposition system to deposit the roads of build material in a particular sequence. For each sliced layer, this generally involves initially depositing the perimeter roads (e.g., outer perimeter road 18 and inner perimeter road 20) to form the perimeters of the layers, and then depositing the raster roads (e.g., raster roads 22) to fill the interior regions of the layers. The deposition timing sequence also directs the system to build layers 32-38 and top layer 14 sequentially by vertically building successive layers on top of previously deposited layers.

Once the layers are sliced, the host computer then generates a pause time in the deposition timing sequence for inserting metal part 16 during the build process (step 56). In the current example, the pause time is inserted in the deposition timing sequence at least after layer 34 is formed, and before top layer 14 is formed. This provides time for placing metal part 16 on layer 34 prior to subsequent depositions. The pause time may also be inserted after layers 36 and 38 are deposited, thereby allowing metal part 16 to be inserted circumferentially within layers 36 and 38. For 3D objects containing multiple metal parts, step 56 may be repeated for each metal part, thereby generating multiple pause times in the deposition timing sequence.

The inserted pause time desirably provides enough time to place metal part 16 at the desired location on top of layer 34. In one embodiment, the pause time also provides an additional amount of time to heat metal part 16 to about an operating temperature of the extrusion-based layered deposition system (i.e., the operating temperature of a build chamber in which 3D object 10 is built). Heating metal part 16 increases the ductility of polymer film 42 and allows metal part 16 to thermally expand prior to the deposition of subsequent layers (e.g., top layer 14).

In another embodiment, the pause time also provides an additional amount of time to scan (e.g., optical scanning) the placement of metal part 16 to ensure that metal part 16 is accurately positioned on layer 34 in the x-y plane. For example, the pause time may include enough time for a scanner to move around within the build chamber and verify the placement of metal part 16 in the x-y plane. Additionally, if the scanning detects that metal part 16 is incorrectly positioned in the k-y plane, the pause time may be increased for a suitable amount time to correct the position of metal part 16 in the x-y plane (manually or in an automated manner). This reduces the risk of metal part 16 being misaligned, which also interferes with formation of subsequent layers.

After the pause time is generated, the host computer then generates build data representing 3D object 10 based at least in part on the generated build paths of the sliced layers and the pause time inserted in the deposition timing sequence (step 58). The build data may also include generated build paths corresponding to support structures for supporting overhanging portions of 3D object 10. The host computer then communicates with the extrusion-based layered deposition system for building 3D object 10 based on the generated build data (step 60).

While method 46 is discussed above as having the order shown in FIG. 3, method 46 may alternatively be performed in different step orders. For example, the location of metal part 16 in step 50 may be performed after one or both of steps 52 and 54 are performed. Furthermore, method 46 may be modified for metal parts that are placed on the top or bottom surface of a given 3D object. In these embodiments, pause times in the deposition timing sequences are not necessary because the metal parts are positioned before or after the layers of build material are formed.

FIG. 4 is a flow diagram of method 62 for building 3D object 10 based on the generated build data representing 3D object 10. While the following discussion relates to 3D object 10, method 62 is also suitable for building 3D objects based on a variety of types of generated build data. Method 62 includes steps 64-72, and is performed with an extrusion-based layered deposition system. Examples of suitable extrusion-based layered deposition systems include fused deposition modeling systems commercially available under the trade designation “FDM” from Stratasys, Inc., Eden Prairie, Minn.

Method 62 initially involves depositing the build material onto substrate 12 to form one or more successive layers (e.g., layers 32, 34, 36, and 38) (step 64). The deposition process is then paused pursuant to the pause time generated in the deposition timing sequence (step 66). While the deposition process is paused, metal part 16 is inserted on layer 34 at the desired location in the x-y plane (step 68). This may be performed in a variety of manners. For example, a user may manually place metal part 16 on layer 34. The previous formation of layers 36 and 38 may assist the user in aligning metal part 16 in the x-y plane by inserting metal part 16 within the circumferential interior of layers 36 and 38.

The user may manually place metal part 16 on layer 34 by reaching into the build chamber of the deposition system and inserting metal part 16 within the circumferential interior of layers 36 and 38. Alternatively, the user may remove substrate 12 and the partially-formed 3D object 10, and then insert metal part 16. Examples of suitable removable substrates for use with this technique are disclosed in Dunn et al., U.S. Publication No. 2005/0173855.

Furthermore, the extrusion-based layered deposition system may include an automated system for placing metal part 16 on layer 34. For example, the deposition system may include a robotic arm under computer control that places metal part 16 on layer 34 with high precision in the x-y plane. In this embodiment, layers 36 and 38 are desirably deposited after metal part 16 is placed on layer 34 to allow the thermoplastic material of layer 36 and 38 to flow against outer diameter 26 of metal part 16 prior to solidifying. This reduces the risk of creating porous cavities at the interface between metal part 16 and layers 36 and 38.

After metal part 16 is inserted on layer 34 at the desired location in the x-y plane, metal part 16 is allowed to heat up to the operation temperature of the extrusion-based layered deposition system (step 70). As discussed above, the pause time generated in the deposition timing sequence may include a period of time for heating metal part 16. Suitable time periods of time will vary depending on the volume, surface area, and the material of metal part 16, and typically range from about 30 seconds to about 10 minutes for small metal parts. Heating metal part 16 increases the ductility of polymer film 42 and thermally expands metal part 16 prior to the deposition of subsequent layers.

In alternative embodiments, metal part 16 may be pre-heated to the operation temperature prior to being inserted on layer 34. For example, metal part 16 may remain within the build chamber of the deposition system at a location offset from substrate 12, thereby allowing metal part 16 to heat up prior to use. Alternatively, metal part 16 may be pre-heated at an external location (e.g., an external oven), and then quickly placed on layer 34 before metal part 16 substantially cools. Pre-heating metal part 16 eliminates the time required to perform step 70 during the build process, thereby reducing the overall build time.

After metal part 16 is inserted and the pause time expires, subsequent layers (e.g., top layer 14) are then deposited on top of metal part 16 and the previously deposited layer (step 72). As discussed above, polymer film 42 increases the adhesive properties of metal part 16. This allows the roads of build material forming top layer 14 (i.e., inner perimeter road 20 and raster roads 22) to be deposited along their intended build paths without smearing or pulling across top surface 24.

While method 62 is discussed above for inserting a single metal part (i.e., metal part 16), method 62 may be modified for the insertion of multiple metal parts in a similar manner. In particular, steps 66-72 are repeated for each metal part inserted (as represented by phantom arrow 74). Furthermore, method 62 may also be modified for metal parts that are placed on the top or bottom surface of a given 3D object. For example, if a metal part is located at a bottom surface of a 3D object, the metal part may be placed on substrate 12 before forming the bottom layer of build material. The layers of build material are then formed on top of the placed metal part and substrate 12, as discussed above. Alternatively, if a metal part is located at a top surface of a 3D object, the layers of build material are formed on top of substrate 12, as discussed above, and the metal part is then inserted on the top layer after the deposition process is complete.

Examples of suitable materials for the build material include any type of extrudable thermoplastic material, such as acrylonitrile-butadiene-styrene (ABS), polycarbonate, polyphenylsulfone, polysulfone, nylon, polystyrene, amorphous polyamide, polyester, polyphenylene ether, polyurethane, polyetheretherketone, and copolymers thereof, combinations thereof. Examples of suitable materials for metal part 16 include any type of metallic material, such as steel, iron, bronze, brass, nickel, gold, silver, and alloys thereof.

As discussed above, polymer film 42 is derived from a adhesion-promoting polymeric material that increases the adhesive properties of metal part 16 at top surface 14. Examples of suitable adhesion-promoting polymeric materials for polymer film 42 include acrylate-containing polymers, alkyd polymers, epoxy-containing polymers, polyurethanes, and combinations thereof. Suitable adhesion-promoting polymeric materials also include cross-linked products of such materials, where the cross-linking (i.e., curing) imparts or increases the adhesion-promoting properties of the materials.

Examples of particularly suitable adhesion-promoting polymeric materials for polymer film 42 include acrylate-containing polymers, and cross-linked products thereof. Suitable acrylate-containing polymers include polymers of acrylate monomers such as cyano methacrylate, cyano acrylate, methyl methacrylate, ethyl methacrylate, n-butyl methacrylate, methyl acrylate, ethyl acrylate, n-butyl acrylate, iso-octyl acrylate, iso-nonyl acrylate, 2-ethyl-hexyl acrylate, decyl acrylate, dodecyl acrylate, n-butyl acrylate, hexyl acrylate, and copolymers thereof.

Top surface 24 (i.e., a polymer-coated surface) may be formed by coating the adhesion-promoting polymeric material onto metal surface 40, and drying the adhesion-promoting polymeric material to form polymer film 42. The adhesion-promoting polymeric material may be coated onto metal surface 40 in a variety of manners, such as with spray coating, knife coating, extrusion coating, and combinations thereof.

Techniques for drying the adhesion-promoting polymeric material on metal surface 40 may vary depending on the chemistry of the adhesion-promoting polymeric material. Examples of suitable drying techniques include gas drying (e.g., air drying) for suitable durations with or without elevated temperatures, condensation curing, thermal curing, radiation curing (e.g., ultraviolet-light curing), and combinations thereof. Suitable layer thicknesses for polymer film after drying range from about 0.01 micrometers to about 50 micrometers. The drying causes the polymeric material to bond to metal surface 40 (e.g., chemical, ionic, and mechanical bonds), thereby securing polymer film 42 to metal surface 40. After drying, metal part 16 may then be used in the build process to form 3D object 10 pursuant to methods 46 and 62, discussed above.

### EXAMPLES

The present invention is more particularly described in the following examples that are intended as illustrations only, since numerous modifications and variations within the scope of the present invention will be apparent to those skilled in the art.

### Examples 1 and 2, and Comparative Example A

The build properties of the 3D objects of Examples 1 and 2, and Comparative Example A were each qualitatively measured pursuant to the following procedure. A first set of layers were formed on a substrate of a fused deposition modeling system commercially available under the trade designation “FDM” from Stratasys, Inc., Eden Prairie, Minn. The layers were formed by depositing roads of white ABS pursuant to build data using control software commercially available under the trade designation “INSIGHT” from Stratasys, Inc.

After the first set of layers were formed, the deposition process was paused to insert the metal part. The metal part used was a steel fender washer generally having the shape shown above in FIG. 1, having an outer diameter of 31.75 millimeters (mm) (i.e., 1.250 inches), an inner diameter of 8.51 mm (i.e., 0.335 inches), and a thickness of 1.27 mm (i.e., 0.050 inches). The metal washers of Examples 1 and 2, and Comparative Example A each included a top surface and a bottom surface. The bottom surface of each metal washer for Examples 1 and 2, and Comparative Example A was coated with a cyanoacrylate adhesive (i.e., crazy glue) for securing the metal washer to the first set of layers of build material.

The top surface of the metal washer for Comparative Example A was untreated. The top surfaces of the metal washers for Examples 1 and 2 were pre-treated to form polymer-coated surfaces having acrylic-polymer films. The top surface of the metal washer for Example 1 was spray coated with an aerosol acrylic polymer commercially available under the trade designation “RUST-OLEUM PAINTER'S TOUCH” #1901 Clear Gloss Multi-Purpose Paint from Rust-Oleum Corporation, Vernon Hills, Ill. The coating was allowed to dry at room temperature for 15 minutes. The top surface of the metal washer for Example 2 was spray coated with an aerosol acrylic polymer commercially available under the trade designation “RUST-OLEUM CRYSTAL CLEAR” #7701 Enamel from Rust-Oleum Corporation. The coating was also allowed to dry at room temperature for 15 minutes.

The metal washer for each of Examples 1 and 2, and Comparative Example A was then inserted onto the first set of layers. The cyanoacrylate adhesive secured the metal washer to the top layer of the first set of layers, thereby preventing movement of the metal washer. The deposition process then resumed, and a single layer was deposited on top of the metal washer and the top layer of the first set of layers. The resulting 3D object was then removed from the deposition system and the build paths of the deposited roads of ABS were visually examined.

The deposited roads of ABS for the 3D object of Comparative Example A were smeared and pulled across the top surface of the metal washer. Accordingly, the layer of ABS deposited on the metal washer did not adequately adhere to the top surface of the metal part, and would interfere with subsequently formed layers of build material.

In contrast, the deposited roads of ABS for the 3D objects of Examples 1 and 2 retained their intended build paths. The roads of ABS deposited on top of the metal washer visually appeared substantially the same as the roads of ABS deposited on the top layer of the first set of ABS layers. Thus, the polymer films disposed on the top surfaces of the metal washers for Examples 1 and 2 increased the adhesive properties of the metal washers, thereby allowing the layers of ABS deposited on the metal washers to be formed as desired. This would allow the resulting 3D objects to be built with extrusion-based layered deposition systems based on the intended build data.

### Example 3 and Comparative Examples B and C

The build properties of the 3D objects of Example 3 and Comparative Examples B and C were each qualitatively measured pursuant to the following procedure. A first set of layers were formed on a substrate of a fused deposition modeling system commercially available under the trade designation “FDM” from Stratasys, Inc., Eden Prairie, Minn. The layers were formed by depositing roads of white ABS pursuant to build data using control software commercially available under the trade designation “INSIGHT” from Stratasys, Inc.

After the first set of layers were formed, the deposition process was paused to insert the metal part. The metal part used was a square piece of metal foil (5.1 centimeters×5.1 centimeters), which included a top surface and a bottom surface. The bottom surface of the metal foil for Comparative Example B was coated with a pro-weld adhesive for securing the metal foil to the first set of layers of build material.

The top surface of the metal foil for Comparative Example B was untreated. The top and bottom surfaces of the metal foil for Example 3 and Comparative Example C were each coated with an industrial-grade epoxy-polymer material commercially available under the trade designation “POWER POXY FOR PROS” from Poxy Plus, Inc., Sussex, Wis.

The metal foil for each of Example 3 and Comparative Examples B and C was then inserted onto the first set of layers. The pro-weld coating (Comparative Example B) and the epoxy coating (Example 3 and Comparative Example C) secured the respective metal foil to the top layer of the first set of layers, thereby preventing movement of the metal foil. The metal foil for Example 3 was also allowed to cure for 30 minutes within the build chamber before the deposition process was resumed. However, for Comparative Examples B and C, the deposition process was resumed immediately after the metal foil was secured to the top layer of the first set of layers. This prevented the epoxy-polymer material used for Comparative Example C from curing before the deposition process was resumed.

For each of Example 3 and Comparative Examples B and C, the resumed deposition process caused a single layer of build material to deposit on top of the metal foil and the top layer of the first set of layers. The resulting 3D object was then removed from the deposition system and the build paths of the deposited roads of ABS were visually examined.

The deposited roads of ABS for the 3D object of Comparative Example B were smeared and pulled across the top surface of the metal foil. Accordingly, the layer of ABS deposited on the metal foil did not adequately adhere to the top surface of the metal part, and would interfere with subsequently formed layers of build material. Similarly, the deposited roads of ABS for the 3D object of Comparative Example C also did not adequately adhere to the top surface of the metal foil. The deposited roads were smeared and pulled across the top surface of the metal foil.

In contrast, the deposited roads of ABS for the 3D objects of Example 3 retained their intended build paths. The roads of ABS deposited on top of the metal foil visually appeared substantially the same as the roads of ABS deposited on the top layer of the first set of ABS layers. Thus, after curing, the epoxy-polymer films disposed on the top surface of the metal foil increased the adhesive properties of the metal foil, thereby allowing the layers of ABS to be formed as desired. A comparison of Example 3 and Comparative Example B illustrates the benefits of curing certain materials to obtain adhesion-promoting properties, where the uncured materials otherwise do not increase the adhesive properties of the metal parts. Accordingly, the use of adhesion-promoting polymeric materials allow the resulting 3D objects to be built with extrusion-based layered deposition systems based on the intended build data.

Although the present invention has been described with reference to preferred embodiments, workers skilled in the art will recognize that changes may be made in form and detail without departing from the spirit and scope of the invention.

1. A method for building a three-dimensional object in a layer-by-layer manner using an extrusion-based layered deposition system, the method comprising:
positioning a metal part within a build chamber of the extrusion-based layered deposition system, the metal part comprising a polymer-coated surface; and
depositing a build material on the polymer-coated surface of the metal part, wherein the deposited build material cools to form at least a portion of a layer of the three-dimensional object, and wherein an adhesion between the build material and the polymer-coated surface is greater than an adhesion between the build material and the metal part.

2. The method of claim 1, wherein the polymer-coated surface comprises a polymer film adhered to an outer surface of the metal part.

3. The method of claim 2, wherein the polymer film comprises a material selected from the group consisting of acrylate-containing polymers, alkyd polymers, epoxy-containing polymers, polyurethanes, and combinations thereof.

4. The method of claim 1, wherein the build material is selected from the group consisting of acrylonitrile-butadiene-styrene, polycarbonate, polyphenylsulfone, polysulfone, nylon, polystyrene, amorphous polyamide, polyester, polyphenylene ether, polyurethane, polyetheretherketone, and combinations thereof.

5. The method of claim 1, wherein positioning the metal part within the build chamber comprises placing the metal part on a previously deposited layer of the build material.

6. The method of claim 1, wherein the extrusion-based layered deposition system comprises a fused deposition modeling system.

7. The method of claim 1, further comprising heating the metal part to about an operating temperature of the build chamber.

8. The method of claim 1, wherein depositing the build material is based at least in part on a deposition timing sequence, and wherein the method further comprises generating a pause time in the deposition timing sequence.

9. A method for building a three-dimensional object in a layer-by-layer manner, the method comprising:
depositing a first build material, wherein the deposited first build material cools to form a first layer of the three-dimensional object;
placing a metal part on a first portion of the first layer, the metal part comprising a polymer-coated surface, wherein the polymer-coated surface comprises an adhesion-promoting polymeric material; and
depositing a second build material on at least a portion of the polymer-coated surface of the metal part and on at least a second portion of the first layer, wherein the deposited second build material cools to form a second layer of the three-dimensional object.

10. The method of claim 9, wherein the adhesion-promoting polymeric material is provided as a polymer film adhered to an outer surface of the metal part.

11. The method of claim 10, wherein the adhesion-promoting polymeric material is selected from the group consisting of acrylate-containing polymers, alkyd polymers, epoxy-containing polymers, polyurethanes, and combinations thereof.

12. The method of claim 9, wherein the first build material and the second build material are each selected from the group consisting of acrylonitrile-butadiene-styrene, polycarbonate, polyphenylsulfone, polysulfone, nylon, polystyrene, amorphous polyamide, polyester, polyphenylene ether, polyurethane, polyetheretherketone, and combinations thereof.

13. The method of claim 9, further comprising heating the metal part prior to depositing the second build material.

14. The method of claim 9, wherein the metal part further comprises a second surface opposite the polymer-coated surface, the second surface comprising an adhesive material.

15. A method for building a three-dimensional object in a layer-by-layer manner using an extrusion-based layered deposition system, the method comprising:
coating a surface of a metal part with an adhesion-promoting polymeric material;
positioning the metal part within a build chamber of the extrusion-based layered deposition system;
depositing a thermoplastic material on at least a portion of the coated surface of the metal part; and
cooling the deposited thermoplastic material to form a layer of the three-dimensional object.

16. The method of claim 15, further comprising drying the adhesion-promoting polymeric material to form a polymer film.

17. The method of claim 15, wherein the adhesion-promoting polymeric material is selected from the group consisting of acrylate-containing polymers, alkyd polymers, epoxy-containing polymers, polyurethanes, and combinations thereof.

18. The method of claim 15, further comprising heating the metal part to about an operating temperature of the build chamber.

19. The method of claim 15, wherein the surface comprises a first surface, and wherein the method further comprises coating a second surface of the metal part with an adhesive material.

20. The method of claim 15, wherein positioning the metal part within the build chamber comprises placing the metal part on a previously deposited layer of the thermoplastic material.
